(19) United States
(12) Patent Application Publication
(10) Pub. No.: US 2004/0188373 A1
(43) Pub. Date: Sep. 30, 2004

(54) Vented, low-drip nursing bottle

(76) Inventors: Julie Maureen Lewis, Portland, OR (US); Daniel J. Bedell, Portland, OR (US)

Correspondence Address: SMITH-HILL AND BEDELL, 12670 N W BARNES ROAD, SUITE 104, PORTLAND, OR, 97229

(21) Appl. No.: 10/397,697

(22) Filed: Mar. 25, 2003

(51) Int. Cl. A61J 9/04; A61J 11/02

(52) U.S. Cl. 215/11.5

(57) ABSTRACT

A nursing bottle includes a container having a threaded neck, a flanged nipple seated on the neck and a cap having a central opening through which the nipple extends. A threaded ring on the cap engages the threaded bottle neck with the outer circumferential edge of the nipple's flange compressed between the annular top and the rim of the bottle neck. A small slit in an area of thinned material at the nipple tip opens when the baby nurses and substantially closes when the baby is not nursing. The nipple flange includes a vent hole between its inner and outer circumferential edges, and an annular bead between its inner circumferential edge and the aperture. The annular bead engages the cap top when air pressure within the container is not substantially lower than air pressure external to the container, thereby providing a seal between the aperture and external air. When the air pressure outside the container is substantially higher than its internal air pressure, the nipple flange moves away from the cap to break the seal between the cap and the flange's annular bead, thereby permitting air to pass through the central opening and into the container via the aperture.

### BACKGROUND OF THE INVENTION

1. Field of the Invention

The present invention relates in general to nursing bottles and in particular to a vented, low-drip nursing bottle.

2. Description of Related Art

Although a possible use for nursing bottles may have arisen on Earth not long after the appearance of mammals, there is scant evidence in the archaeological record of attempts to fulfill that need prior to Roman times. Ceramic pitchers with nipple-like spouts have been found in ancient tombs of Roman babies. Such an apparatus would have been appreciated by the Roman mother who, leaving nanny to attend to baby's feeding, would have been free perhaps to spend an afternoon socializing at the baths or watching the latest spectacle at the local coliseum without having to tote baby along. While mother may have considered such a nursing bottle to be a blessing, nanny may have thought otherwise. To feed a baby using this device would have required more than a little dexterity and concentration, as Nanny would have had to insert the nipple into baby's mouth and tilt the pitcher when baby wanted to nurse and then quickly return it to upright when baby wanted to stop nursing. Any miscalculation as to the timing of the baby's intention to stop nursing, or an unexpected kick from baby, could result in a major spill. Baby may not have been completely happy with the device either, finding a cold, hard ceramic nipple a poor substitute for the real thing.

Despite the deficiencies of the Roman nursing bottle, there was little improvement to the basic design until the invention of the rubber nipple in the mid 19th century, one of the earliest and arguably most greatly appreciated applications of rubber. Examples of flexible nipples made of natural or synthetic rubber, plastic and other materials for nursing bottles are described in the following patents:

U.S. Pat. No. 22,579 issued Jan. 11, 1859 to Potter

U.S. Pat. No. 26,327 issued Nov. 29, 1859 to La Forme,

U.S. Pat. No. 467,176 issued Jan. 19, 1892 to Jensen

U.S. Pat. No. 605,161 issued Jun. 7, 1989 to Clement et al

U.S. Pat. No. 586,011 issued Jul. 6, 1897 to Butz,

U.S. Pat. No. 589,212 issued Aug. 31, 1897 to Michael,

U.S. Pat. No. 785,707 issued Aug. 11, 1903 to Cantwell,

U.S. Pat. No. 1,099,082 issued Jun. 2, 1914 to Decker,

U.S. Pat. No. 5,035,340 issued Jul. 30, 1991 to Timmons,

U.S. Pat. No. 6,161,710 issued Dec. 19, 2000 to Dieringer, and

U.S. Pat. No. 6,250,487 issued Jun. 26, 2001 to Tebeau

With the fluid fully enclosed except for a small slit or hole in the tip of the nipple sized to provide sufficient flow to the baby, it was no longer necessary for mother or nanny to be quite so attentive or skillful to avoid major spills.

A nursing bottle having an opening only in the nipple tip does have a drawback. As the baby draws fluid out of the bottle though the nipple, air in the bottle must expand to fill the void let by the departing fluid, thereby lowering the air pressure in the bottle. As the air pressure in the bottle continues to decline, the baby must suck harder on the bottle to remove additional fluid, until at some point the partial vacuum in the bottle has grown so strong the baby is no longer able to draw any more fluid out of the bottle. Although the baby need only stop nursing and calmly allow the bottle to draw additional air back into the bottle through the hole in the nipple tip, thereby relieving the partial vacuum, not all hungry babies have the foresight to do that. Many prefer to continue desperately sucking without success until, red-faced and frustrated, they give up and cry.

Sympathetic inventors have resolved this problem by providing a vent to permit air to enter the bottle to replace the departing fluid while the baby is nursing The following U.S. patents teach the use of a one-way valve in the bottom of the nursing bottle to vent the bottle as the baby nurses:

U.S. Pat. No. 362,554 issued May 10, 1887 to Suydam,

U.S. Pat. No. 1,037,309 issued Sep. 3, 1912 to Poore,

U.S. Pat. No. 2,084,099 issued Jun. 15, 1937 to Maccoy,

U.S. Pat. No. 3,768,683 issued Oct. 30, 1973 to Van Den Bosch,

U.S. Pat. No. 4,685,577 issued Aug. 11, 1987 to Chen,

U.S. Pat. No. 4,828,126 issued May 9, 1989 to Vincinguerra, and

U.S. Pat. No. 5,607,074 issued Mar. 4, 1997 to De Gennaro,

But a bottle having a bottom valve is difficult and expensive to manufacture, and the valves may have small parts that are difficult to clean. The following U.S. patents describe a nursing bottle employing a disposable, collapsible bag in lieu of a rigid bottle for holding the fluid:

U.S. Pat. No. 3,718,140 issued Feb. 27, 1973 to Yamauchi,

U.S. Pat. No. 3,822,806 issued Jul. 9, 1974 to Grimes,

U.S. Pat. No. 4,339,046 issued Jul. 13, 1982 to Coen,

Since the bag collapses as the baby nurses, there is no need to vent it. A less expensive approach is to provide one or more vents in areas of the nipple remaining outside the baby's mouth, as the baby nurses. The following U.S. patents teach variations on that approach:

U.S. Pat. No. 1,146,639 issued Jul. 13, 1915 to Miller,

U.S. Pat. No. 2,174,361 issued May 16, 1936 to Condon

U.S. Pat. No. 2,616,581 issued Nov. 4, 1953 to Madsen et al,

U.S. Pat. No. 2,753,067 issued Jul. 3, 1956 to Rodrigues,

U.S. Pat. No. 2,942,746, issued May 31, 1957 to Porthouse et al,

U.S. Pat. No. 2,960,088 issued Nov. 15, 1960 to Witz,

U.S. Pat. No. 2,996,207 issued Aug. 15, 1961 to Witz,

U.S. Pat. No. 3,113,569 issued Dec. 10, 1963 to Barr et al,

U.S. Pat. No. 3,492,139 issued Feb. 18, 1970 to Faddoul et al,

U.S. Pat. No. 5,474,028 issued Dec. 12, 1995 to Larson et al,

U.S. Pat. No. 5,797,505 issued Aug. 25, 1998 to Kaura

U.S. Pat. No. 5,881,893 issued Mar. 16, 1999 to Manganiello

When a baby is not nursing, fluid can leak out of a nursing bottle through the hole in the nipple tip. When the baby holds the bottle in his or her mouth without nursing, as for example when the baby falls asleep without releasing the nipple, continual leakage of milk or other fluid into the baby's mouth can cause tooth decay and other problems. Such leakage is particularly troublesome when the hole in the nipple tip is made relatively large to accommodate a flow rate sufficient for larger babies. One approach to reducing such leakage is provide an aperture in the nipple tip that opens to permit increased fluid flow when a baby is nursing and then substantially closes when the baby is not nursing to reduce the amount of leakage. One way to do that is to form a slit in an area of the nipple tip that is very thin and flexible. When the baby depresses the nipple and draws fluid through the slit, the slit opens to permit fluid flow, but when the baby stops nursing, the slit closes to reduce leakage. The following U.S. patents disclose this idea:

U.S. Pat. No. 2,688,326 issued Sep. 7, 1954 to Lerman, and

U.S. Pat. No. 3,718,140 issued Feb. 27, 1973 to Yamauchi.

This type of nipple tip can substantially reduce the amount of fluid that drips out of the tip of a non-vented bottle when a baby is not nursing since flow out of the tip is opposed by a residual partial vacuum in the bottle that tends to keep the slit closed. However since a vented bottle does not allow a partial vacuum to form within the bottle, leakage could potentially occur though through even a relatively small slit. Fluid can also drip through a vented bottle's air vent when the vent does not provide a tight seal when the baby is not nursing.

What is needed is a vented nursing bottle that is inexpensive to manufacture, that allows for regulation of outflow to accommodate a baby's age or demand and that does not leak substantially when the baby stops nursing.

### BRIEF SUMMARY OF THE INVENTION

A nursing bottle in accordance with the invention includes a container having a threaded neck, a flanged nipple seated on the neck and a threaded, annular cap having a central opening through which the nipple extends. A threaded ring on the cap engages the threaded bottle neck and compresses the outer circumferential edge of the nipple's flange between the cap's annular top and the rim of the bottle neck.

The nipple is formed of resilient material that is thinned in an area at its tip. A small slit in the area of thinned material at the nipple tip opens when the baby nurses and substantially closes when the baby is not nursing to help reduce leakage through the slit.

The nipple's flange includes a vent hole between its inner and outer circumferential edges, and an annular bead between its inner circumferential edge and the aperture. The nipple's annular bead engages the cap top when air pressure within the container is not substantially lower than air pressure external to the container thereby providing a seal preventing external air from flowing into the container via the aperture in the flange. When the internal air pressure within the container falls substantially below the external air pressure as the baby removes fluid from the container, the external air pressure pushes the nipple flange away from the cap to break the seal between the cap top and the flange's annular bead. This permits vent air to pass through the central opening and into the container via the aperture. After the baby stops nursing, the vent air reduces the differential between the internal and external air pressure to a point where the external air pressure can no longer keep the annular bead from contacting the cap top and cutting off the flow of vent air into the container before the vent air can completely eliminate the partial vacuum within the container.

The seal between the annular bed and the cap top prevents fluid from leaking though the vent hole in the flange. A modest residual partial vacuum in container tends to keep the slit in the nipple tip closed to prevent fluid leakage through slit.

The claims appended to this specification particularly point out and distinctly claim the subject matter of the invention. However those skilled in the art will best understand both the organization and method of operation of what the applicant(s) consider to be the best mode(s) of practicing the invention, together with further advantages and objects of the invention, by reading the remaining portions of the specification in view of the accompanying drawing(s) wherein like reference characters refer to like elements.

### BRIEF DESCRIPTION OF THE DRAWINGS

FIG. 1 is a plan view of a nipple for a nursing bottle in accordance with the invention;

FIG. 2 is a sectional elevation view of the nipple of FIG. 1 taken along cut line 2-2;

FIGS. 3 and 4 are sectional elevation views of a top portion of a nursing bottle in accordance with the invention; and

FIGS. 5 and 6 are sectional elevation views of a top portion of a nursing bottle in accordance with an alternative embodiment of the invention.

### DETAILED DESCRIPTION OF THE INVENTION

The present invention relates to a nursing bottle having an outlet aperture that opens when a baby is nursing and then substantially closes to reduce leakage when the baby stops nursing. The nursing bottle also includes an air inlet valve that opens to vent the bottle when the baby is nursing and then closes when the baby stops nursing to inhibit fluid leakage. While the specification describes at least one exemplary embodiment of the invention considered to be a best mode of practicing the invention, the invention is not limited to the exemplary embodiment(s) described below or to the manner in which the exemplary embodiments operate.

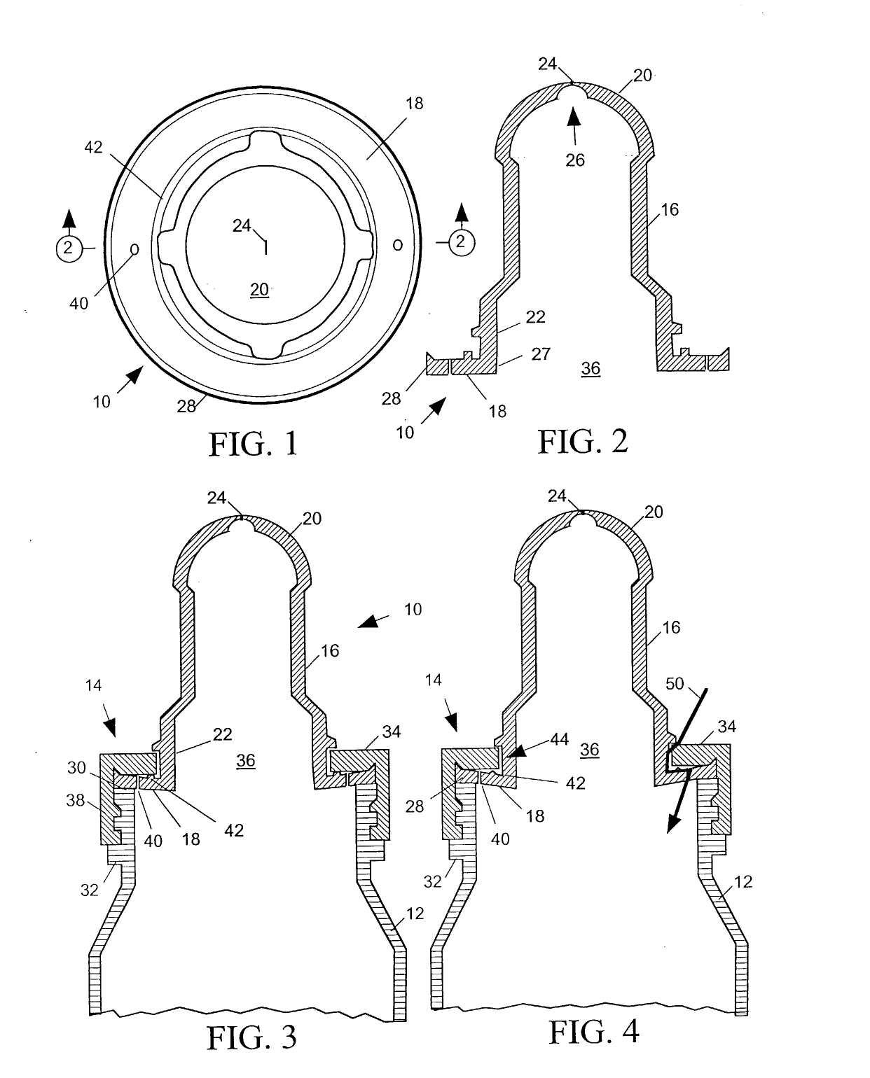

FIG. 1 is a plan view of a nipple 10 for a nursing bottle in accordance with the invention and FIG.2 is a sectional elevation view of nipple 10 take along cut line 2-2. FIGS. 3 and 4 are sectional elevation views of a top portion of the bottle in accordance with the invention, including a cap 14 for holding nipple 10 on a glass or plastic container 12.

Referring to FIGS. 1-4, nipple 10 includes a hollow nipple body 16 and an annular flange 18 of flexible material such as natural or synthetic rubber or plastic. Nipple body 16 includes a tip 20 joined to an annular base 22 that is in turn joined to flange 18. Nipple tip 16 includes a small, thin slit 24 forming a first aperture in nipple tip 16 to act as a fluid outlet. The flexible material in an area 26 surrounding slit 24 is of reduced thickness in relation to that of other areas of the nipple 10 to allow the aperture formed by slit 24 to open while a nursing baby draws fluid through the slit so as to satisfy the baby's demand for fluid and to thereafter substantially close when the baby stops not drawing fluid through the aperture so as to limit fluid leakage. Although the slit self-regulates flow rate based on how hard the baby sucks, the length the slit 24 also influences fluid flow rate. Slit 24 is suitably made relatively short for small babies demanding relatively low flow rates and relatively long for larger babies demanding relatively high flow rates.

Annular nipple flange 18 includes an inner circumferential edge 27 joined to the base 22 of nipple body 16 and an outer circumferential edge 28 seated on the rim 30 of the threaded neck 32 container 12. Retainer cap 14 includes an annular top 34 with a central opening 36 through which nipple base 22 extends. Retainer cap 14 also includes a threaded annular ring 38 for engaging threaded bottle neck 32 to compress the outer circumferential edge 28 of nipple flange 18 between cap top 34 and container neck rim 30, thereby providing a tight seal between nipple 10 and container rim 30.

Apertures 40 in flange 18 between its inner and outer circumferential edges 26 and 28 provide passages for air to enter container 12 when a nursing baby creates a partial vacuum within the container by removing fluid from the container via nipple slit 24. Nipple flange 18 includes an annular bead 42 between its annular inner edge 26 and apertures 40. When cap 14 is screwed onto container neck 32 to compress outer circumferential edge 28 between cap top 34 and container rim 30, cap top 34 also presses down on bead 42, deflecting flange 18 downward. Since flange 18 is made of resilient material, its deformation causes it to apply an upward force on annular bead 42 opposing the downward force applied by cap top 34. The opposing forces hold annular bead 42 tightly against the under side of cap top 34 as illustrated in FIG. 3, forming a seal between annular bead 42 and cap top 34 preventing air or fluid from passing between aperture 40 and the central opening 36 of cap 14

When a nursing baby creates a substantial partial vacuum in container 12 by removing fluid though slit 24, external air pressure pushes nipple 10 downward, further deflecting the inner circumferential edge 26 downward as illustrated in FIG. 4 and breaking the seal between annular bead 42 and cap top 34. With the seal broken, vent air 50 follows a path shown by the arrow in FIG. 3 through a gap 44 between cap top 34 and nipple base 22, though the space between annular bead 42 and cap top 34, through holes 40 and into container 12 to relieve the partial vacuum in container 12.

When the baby stops nursing, vent air continues to flow into container 12 until the air pressure differential between air inside and outside container 12 becomes sufficiently low to allow the upward force provided by deformed flange 18 to again push bead 42 into contact with cap top 34 to cut off further air flow into the bottle.

The fluid outlet valve formed by slit 24 in tip area 26 and the air inlet valve formed by flange 18 and cap top 34 work together to provide fluid flow through slit 24 matching the baby's demand when the baby is nursing, and to substantially reduce or eliminate fluid leakage when the baby is not nursing. Slit 24 opens to permit fluid flow when the nursing baby sucks on and squeezes the nipple, and closes to substantially prevent fluid leakage when the baby stops nursing on the nipple. The air inlet valve formed by flange bead 18 and cap top 34 opens to allow vent air to enter container 12 through apertures 40 when the baby nurses, but closes tightly under substantial pressure from deflected flange 18 to cut off the flow of vent air after the baby stops nursing. Since the inlet valve cuts off the flow of vent air into container 12 before the vent air can completely eliminate the partial vacuum within container 12, the residual partial vacuum in container 12 helps to keep slit 24 in nipple tip 20 closed to prevent fluid leakage through slit 24.

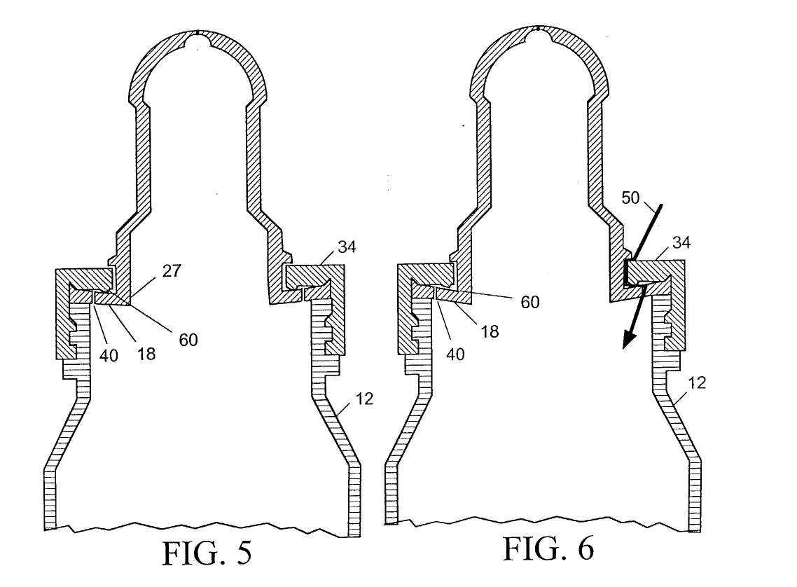

FIGS. 5 and 6 illustrate an alternative embodiment of the nursing bottle in accordance with the invention that is substantially similar to the embodiment depicted in FIGS. 1-4 except that instead of providing annular bead 42 on the nipple flange 18 as in FIGS. 1-4, a bead 60 is instead provided on the underside of cap top 34. Bead 60 is positioned to contact flange 18 between its aperture 40 and its inner circumferential edge 27 as illustrated in FIG. 5 when air pressure in container 12 is not substantially lower than outside air pressure so as to prevent vent air from flowing through aperture 40. When air pressure in container 12 falls substantially below outside air pressure, flange 18 pulls away from bead 60 as shown in FIG. 6 to permit vent air 50 to flow into container 12 via aperture 40.

Those of skill in the art will appreciate that alternative embodiments of the nursing bottle in accordance with the invention can be adapted for nursing animals other than humans. A similar type of bottle can be used for other purposes. For example when container 12 is made of a resilient material such as plastic, bottle 10 can be used as a squeeze bottle for dispensing fluids such as glue and chemical. When a user squeezes container 12, bead 42 contacts cap top 34 to close the air inlet valve and fluid is ejected though slit 24 which opens to accommodate fluid flow.

When the user stops squeezing bottle 10, slit 24 closes, and bead 42 disengages from cap top 34 to allow vent air to enter container 12. When the incoming vent air has increased air pressure inside container to a level near that of outside air, bead 42 re-engages cap top 34 to seal the air vent.

Thus has been described a nursing or fluid dispensing bottle having a slitted outlet valve that substantially closes after a baby stops nursing to help reduce leakage. The bottle also includes an air inlet valve that opens to provide vent air when there is a substantial vacuum in the bottle but which closes while there is still a residual partial vacuum in the bottle. The residual partial vacuum helps help keep fluid from leaking out of the outlet valve. A nursing or other type of fluid dispensing bottle having these two features permits fluid to flow out of the bottle at a rate sufficient to meet user demand for the fluid but substantially limits leakage from the bottle when there is no demand for fluid.

The foregoing specification and the drawings depict exemplary embodiments of the best mode(s) of practicing the invention, and elements or steps of the depicted best modes exemplify the elements or steps of the invention as recited in the appended claims. However the appended claims are intended to apply to any mode of practicing the invention comprising the combination of elements or steps as described in any one of the claims, including elements or steps that are functional equivalents of the example elements or steps of the exemplary embodiment(s) of the invention depicted in the specification and drawings.

1. An apparatus for dispensing liquid comprising:
a hollow nipple body having a tip and an annular base; and
a resilient annular nipple flange formed of the flexible material having an inner circumferential edge joined to the annular base of the nipple body, the flange having inner and outer circumferential edges, having an aperture between its inner and outer circumferential edges and having a raised annular bead between its annular inner edge and the aperture.

2. An apparatus for dispensing liquid comprising:
a hollow nipple body having a tip and an annular base, the nipple tip having a first aperture therein providing an outlet for the fluid; and
a resilient annular nipple flange formed of the flexible material having an inner circumferential edge joined to the annular base of the nipple body, the flange having inner and outer circumferential edges, having a second aperture between its inner and outer circumferential edges and having a raised annular bead between its annular inner edge and the second aperture.

3. The apparatus in accordance with claim 2, wherein the nipple body is formed of a flexible material allowing the first aperture to open to permit substantial fluid flow through the aperture when fluid is being forced through the first aperture, and to thereafter substantially close when fluid is not being forced through the first aperture to limit fluid leakage through the first aperture.

4. The apparatus in accordance with claim 3 wherein a portion of the flexible material surrounding the first aperture is of substantially reduced thickness in relation to the flexible material forming other areas of the nipple body.

5. The apparatus in accordance with claim 4 wherein the first aperture is formed by an elongate slit in the flexible material.

6. The apparatus in accordance with claim 2 further comprising:
a container for holding the fluid and air, the container including a neck having a rim, the nipple flange's circumferential edge being seated on the rim of the container; and
a retainer cap having an annular top including a central opening through which the nipple body extends, having an annular ring joined to the annular top for engaging the bottle neck and holding the outer circumferential edge of the nipple flange in compression between the annular top and the container neck rim.

7. The apparatus in accordance with claim 6
wherein when air pressure within the container is not substantially lower than air pressure external to the container, the retainer cap's annular top engages the nipple flange's annular bead deforming the nipple flange so that it applies a substantial force pressing its annular bead against the annular top, the annular bead and the annular top thereby providing a seal impeding air and liquid flow between the second aperture and the central opening in the retainer cap's annular top, and
wherein when the air pressure within the container is substantially lower than air pressure external to the container, the annular bead of the nipple flange disengages from the annular top of the retainer cap breaking the seal, thereby permitting air to pass into the container via the central opening of retainer cap and the second aperture.

8. The apparatus in accordance with claim 7,
wherein the nipple body is formed of a flexible material allowing the first aperture to open to permit substantial fluid flow though the first aperture while fluid is being drawn through the first aperture, and to thereafter substantially close when fluid is not being drawn through the first aperture to substantially restrict fluid flow through the first aperture.

9. The apparatus in accordance with claim 8 wherein a portion of the flexible material surrounding the first aperture is of substantially reduced thickness in relation to the flexible material forming other areas of the nipple body.

10. The apparatus in accordance with claim 9 wherein the first aperture is formed by an elongate slit in the flexible material.

11. The apparatus in accordance with claim 2 further comprising:
a container of resilient material for holding the fluid and air, the container including a neck having a rim, the outer circumferential edge of the nipple flange being seated on the rim of the container; and
a retainer cap having an annular top including a central opening through which the nipple body extends, having an annular ring joined to the annular top for engaging the bottle neck and holding the outer circumferential edge of the nipple flange in compression between the annular top and the container neck rim

12. The apparatus in accordance with claim 11
wherein when the container is squeezed with the first aperture residing below the fluid, the fluid is forced though the first aperture, and such that when the container is not being squeezed, fluid is not forced though the first aperture,
wherein when air pressure within the container is not substantially lower than air pressure external to the container, the retainer cap's annular top engages the nipple flange's annular bead deforming the nipple flange and applying a substantial force pressing the annular bead against the retainer cap's annular top, the annular bead and the annular top thereby providing a seal to impede air and liquid flow between the second aperture and the central opening in the retainer cap's annular top, and
wherein when the air pressure within the container is substantially lower than air pressure external to the container, the annular bead of the nipple flange disengages from the annular top of the retainer cap breaking the seal, thereby permitting air to pass into the container via the central opening of container and the second aperture.

13. The apparatus in accordance with claim 11,
wherein the nipple body is formed of a flexible material allowing the first aperture to open to permit increased fluid flow through the first aperture when fluid is being forced through the first aperture, and to thereafter substantially close when fluid is not being forced through the first aperture to limit fluid flow through the aperture.

14. The apparatus in accordance with claim 13
wherein a portion of the flexible material surrounding the first aperture is of reduced thickness in relation to the flexible material forming other areas of the nipple body.

15. The apparatus in accordance with claim 14 wherein the first aperture is formed by an elongate slit in the flexible material.

16. An apparatus for holding and dispensing fluid comprising:
a container for holding the fluid and air, the container including a neck having a rim;
a hollow nipple body having a tip and an annular base, wherein the nipple tip includes a first aperture therein providing an outlet for the fluid;
a resilient annular nipple flange formed of the flexible material having an inner circumferential edge joined to the base of the nipple body, having an outer circumferential edge seated on the rim of the container, having a second aperture between its inner and outer circumferential edges; and
a retainer cap having an annular top including a central opening through which the nipple body extends, having a ring joined to the annular top for engaging the bottle neck and holding the outer circumferential edge of the nipple flange in compression between the annular top and the container neck rim, and having an annular bead extending downward from of the annual top for engaging the nipple flange between its annular inner edge and the second aperture.

17. The apparatus in accordance with claim 16
wherein when air pressure within the container is not substantially lower than air pressure external to the container, the annular beach engages the nipple flange annular bead deforming the nipple flange so that it applies a substantial force pressing the annular bead against the flange, the annular bead and the flange thereby providing a seal to impede air and liquid flow between the second aperture and the central opening in the retainer cap's annular top, and
wherein when the air pressure within the container is substantially lower than air pressure external to the container, the annular bead disengages from the nipple flange breaking the seal, thereby permitting air to pass into the container via the central opening of container and the second aperture.

18. The apparatus in accordance with claim 17
wherein the nipple body is formed of a flexible material allowing the first aperture to open to permit increased fluid flow through the first aperture while fluid is being drawn through the first aperture, and to thereafter substantially close when fluid is not being drawn through the first aperture to limit fluid leakage through the aperture.

19. The apparatus in accordance with claim 18 wherein a portion of the flexible material surrounding the first aperture is of reduced thickness in relation to the flexible material forming other areas of the nipple body.

20. The apparatus in accordance with claim 19 wherein the first aperture is formed by an elongate slit in the flexible material.
